(19) United States
(12) Patent Application Publication
(10) Pub. No.: US 2013/0249221 A1
(43) Pub. Date: Sep. 26, 2013

(54) Self Closing Gate Latch with Knob

(71) Applicants: John Arssinous, San Jose, CA (US); Azin Farassat, San Jose, CA (US)

(72) Inventors: John Arssinous, San Jose, CA (US); Azin Farassat, San Jose, CA (US)

(21) Appl. No.: 13/427,479

(22) Filed: Mar. 22, 2012

(51) Int. Cl. E05C 1/12

(52) U.S. Cl. 292/173; 292/143

(57) ABSTRACT

A push button-knob gate latch assembly comprising of: a knob handle, a Center bar (striker); and a gate latch assembly to be mounted to a fence/gate. The push button knob handle is mounted on the exterior of the stationary fence (on the wood post) and includes three round rods and other simple mechanical components which extend through the fence post and connect to the latching device which is secured to the inside of the fence (on the wood post). Pressing the push-button knob moves the center rod and pulls on the closed latch releasing the locking mechanism and freeing the center bar or the striker. Due to its special design, the gate latch locks down on the center bar every time the gate is pushed to a close position and assures a secure closed position.

### PRIOR ART

The following is a tabulation of some prior art that presently appears relevant:

U.S. Patent Documents

| | | |
|---|---|---|
| 204267 | May 1878 | Under |
| 37567 | February 1863 | Cooper |
| 1235560 | August 1917 | Deloatch |
| 1591383 | July 1926 | HEBZIUO et al |
| 2627433 | February 1953 | Wolfe |
| 3266831 | August 1966 | Banse |
| 3433518 | March 1969 | Foltz |
| 4305611 | December 1981 | Robins |
| 5078438 | January 1992 | Bieganski |
| 5106131 | April 1992 | Wilcox |
| 5116090 | May 1992 | Nichandros |
| 5358292 | October 1994 | Van Wiebe et al. |
| 5498041 | March 1996 | Bezzerides et al. |
| 5655801 | August 1997 | Casey |
| 6058747 | May 2000 | Doyle et al. |
| 6,170,892 | January 2001 | Lantiegne |
| 6513351 | February 2003 | Clark |

### BACKGROUND OF THE INVENTION

1. Field of the Invention

The present invention relates to latches, and in particular to gravity latches.

2. Brief Statement of the Prior Art

Gravity latches are well known. They provide a simple mechanical closure mechanism generally used with gates or outside doors and fences and the like. Typically, such latches incorporate a latch bolt or center bar which is fastened to the gate; and, a pivotable latching member which is fastened to the gate post, in alignment with the center bar. When the gate is closed, the center bar is forced past the latch plate, which then drops into position over the center bar, thus capturing the bar and holding the gate in the closed position. To open the gate one lifts the latch plate clear of the center bar, thereby allowing the bar to swing clear of the latch plate when a force is applied to open the gate. The gate can, therefore, be closed without it being necessary for the user to physically actuate the gravity latch, but cannot be opened without the user moving the center bar from the latch plate.

Another prior art technique is to pivotally attach a rod to the side of the gate, near the latch, such that opposed ends of the rod project outwardly from either side of the gate, when the gate is closed A short length of string or chain couples the latch plate to the rod end which projects outwardly on the latch side of the gate. A person wishing to open the gate from the side opposite the latch pivots the rod, thereby lifting the latch plate and freeing the latch bolt so that the gate can be opened.

Another frequently employed technique is to drill a hole through the gate post. One end of a piece of string, rope, cord, chain, etc. is fixed to the latch plate. The opposite end is threaded through the gate post hole and left hanging from the side of the gate post opposite that to which the latch plate is fastened. A person wishing to open the gate from the side opposite the latch may pull the hanging string, thereby lifting the latch plate and freeing the latch bolt so that the gate can be opened. Various embodiments of this “string pull” technique are disclosed in U.S. Pat. No. 1,235,560 issued Aug. 7, 1917 for an invention of Deloatch entitled “Gate Latch”; U.S. Pat. No. 3,266,831 issued Aug. 16, 1966 for an invention of Banse entitled “Automatic Latch”; and in U.S. Pat. No. 3,433,518 issued Mar. 18, 1969 for an invention of Foltz entitled “Latch Assembly”.

The “string pull” technique is relatively unsophisticated and prone to breakage of the string. The prior art has however evolved a variety of “push-pull” rod type mechanisms for controlling the opening and closing of gate or door latches. For example, U.S. Pat. No. 37,567 issued Feb. 3, 1863 for an invention of Cooper entitled “Door Latch” discloses a mechanism in which a rod is connected between handles provided on opposite sides of a door. The rod is connected to a door latch mechanism to enable the latch to be opened or closed by pushing or pulling either of the handles, depending upon the side from which the door is to be opened. U.S. Pat. No. 1,591,383 issued Jul. 6, 1926 for an invention of Herzing entitled “Closure Latch”; and, U.S. Pat. No. 2,627,433 issued Feb. 3, 1953 for an invention of Wolfe entitled “Door Latch” disclose other “push-pull” rod type mechanisms comparable to that of Cooper.

Although providing more positive control over the latch mechanism than the “string pull” technique, the “push-pull” rod techniques exemplified by Cooper, Herzing and Wolfe are directed to use with specific latch mechanisms. More particularly, these prior art arrangements are unsuited to use with the commonly used gate latch described above. The present invention provides a gate latch control device specifically adapted for use with such gate latches. These inventions, although better than prior art, are also somewhat complicated and difficult to assemble.

### OBJECTIVES

### Advantages of the Invention

In view of the foregoing, it should be apparent that a need still exists in the prior art for a gate latch system that avoids the problems inherent in the prior art systems.
a) Accordingly, it is a primary object of the present invention to provide a gate latch assembly that uses a push button knob mechanism located outside the gate structure which opens and closes a gate latch and center bar every time, effortlessly and without mechanical issues.
b) It is an objective of this invention to provide an improvement in a gate latch.
c) It is an additional objective of this invention to provide a gate latch which is easy to install.
d) It is also an objective of this invention to provide a gate latch which is inexpensive, comprised of relatively few and/or simple-to-manufacture component parts, and provides improved durability and service life.
e) It is another object and advantage of the present invention to provide a gate latch system adapted to secure the latch every time upon closure of the gate through its self-closing mechanism.
f) Another object and advantage of the present invention is to provide a gate latch that does not require any through holes for a string mechanism through either the gate or the fixed post.
g) It is likewise an objective of this invention to provide a gate latch which can be installed in a right-handed or left-handed configuration.

### SUMMARY OF THE INVENTION

In accordance with the foregoing objects and advantages, the present invention comprises a latch system adapted to secure a movable gate relative to a fixed post, said system comprising a latching bar adapted for mounting on said fixed post, a knob button assembly adapted for mounting on said fixed post; said knob button assembly comprising base mountable on said fixed post, the end of an internal center rod extendably mounted on said knob button base; said latch assembly comprising a latch bar mounted on said fixed post, a latch housing mounted on said fixed post.

### DRAWINGS—FIGURES

In the drawings, related parts have the same numbers.

FIG. 1—Shows the Push button gate latch with knob fully assembled.

FIG. 2—Shows the Pre-assembled parts, item #s 3-4 and 6-11.

FIG. 3—Shows all of the individual parts which make up the said new device.

FIG. 4—Shows a closer picture of the novel and original modification to previous arts which creates the various benefits and advantages of this invention. This new modification insures that the gate latch releases the center bar and the gate is opened once the knob is pressed, and then goes back to its original resting position once the knob is released. The modification ensures that upon closure of the gate, the gate latch opens up to house the center bar and secures it in place by going back to its resting/closed position every time.

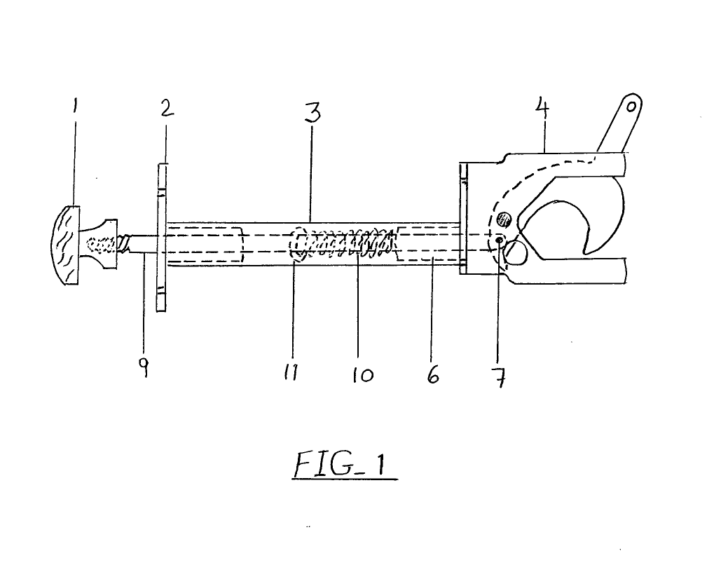

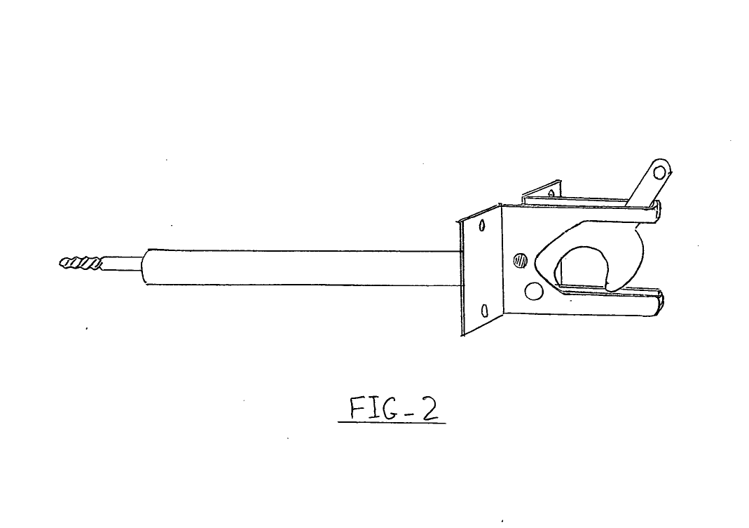

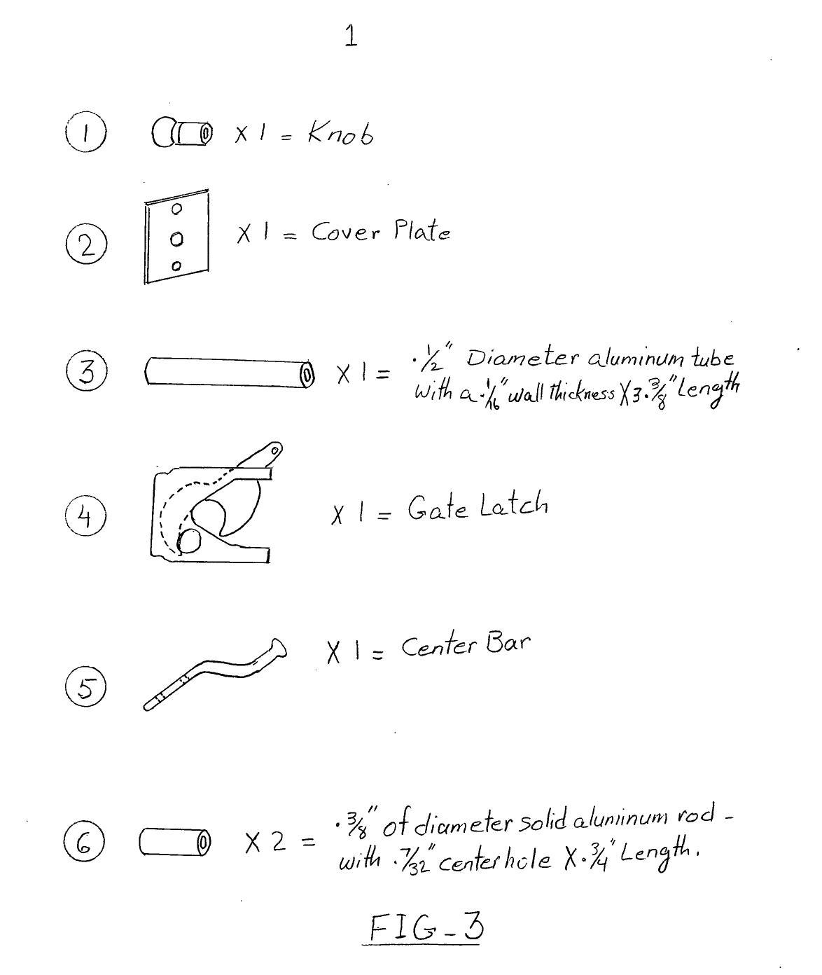

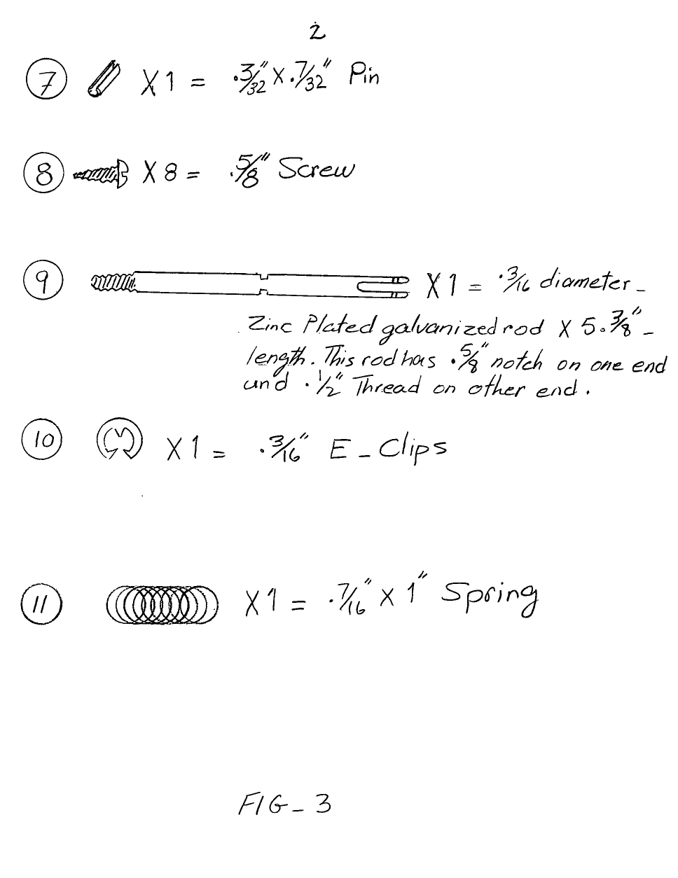

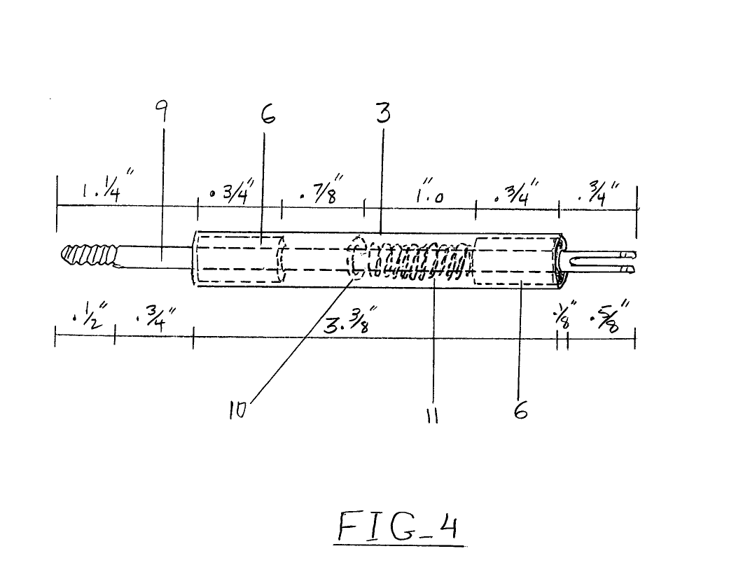

### DETAILED DESCRIPTION OF FIGS. 1-4:

1) Push button-knob Handle—Located outside of the gate. Used to open the door.
2) Cover Plate—The cover plate sits on the end of the handle against the wood post. This part is attached to the post by two ⅝″ screws.
3) Aluminum Tubing—½″ in diameter with a 1/16″ thick wall×3⅜″ length. This tube sits inside the gate post which holds various parts (item #6, #9, #10 and #11) in place, extending from the latch to the door knob.
4) Gate Latch (latch bracket)—mounted on the wooden post and consists of a lever to keep the center bar (item #5) locked in. On the bottom tail of the latch, there is a hole which houses the Latch pin (item #7).
5) Center Bar—The center bar is attached to the free gate door and locks in to the gate latch (item #4).
6) Solid Aluminum tubing—These ⅜″ in diameter solid rods with a 3/16″ center hole and ¾″ length tubes reside inside the aluminum tube #3 (on either end of the tube) and they hold the center rod (item #9) in place. One of these tubes sits at the tip of the gate latch inside the gate post, and the other one sits at the other end of tube #3 closest to the cover plate.
7) Latch Pin— 3/32″× 7/32′ pin which resides inside the gate latch and connects the center rod (item #9) to the latch (item #4).
8) Wood Screws—⅝″ screws used to fasten the gate latch (item #4) and latch Center Bar (item #5) and the cover plate (item #2) to the gate post.
9) Center Rod—The center rod is attached to the gate latch (item #4) on one end via the Latch pin (item #7) and to the gate knob on the other end. The center rod resides inside two tubes (item #3 and 6) which help keep it in place.
10) E-Clip—The E-clip is 3/16″ and is mounted on the center rod (item #9) and on the end of the spring (item #11) farthest away from the gate latch, and is stationary. Its function is to push the center rod (item #9) and the spring at the same time toward a forward motion when the gate knob is pushed in order to open the gate latch.
11) Spring—This 7/16″ by 1″ spring is mounted on the end of the aluminum rod (item #6) closest to the gate latch and in front of the E-clip (item #10). Its function is that once the knob (item #1) is pushed from the outside of the gate post, the spring along with the e-clip extends the rod outward, which in turn opens up the gate latch.

This gate latch is typically employed in connection with a stationary gate post mounted adjacent the free edge of a hinged gate. The gate is typically secured to an additional stationary fence post by a hinge. A Lever/center bar (5) is secured to the gate by a pair of conventional wood screws (8). The center bar (5) typically includes a right angle bend portion such that the latch bar is disposed in alignment for engagement in a latch bracket (4) secured to the stationary gate post by conventional wood screws (8). The latch bracket includes a lever which closes down on the center bar (5) to keep it in place. The gate latch (4) connects to a center rod (9) ½″ in diameter aluminum tubing via a pin (7) and runs through the gate post inside two ⅜″ in diameter aluminum tubings (3 and 6), ending at the cover plate (2) on the outside of the gate door where it is then screwed in to the push-button knob (1). The cover plate is mounted on to the push-button knob (1). The cover plate (2) which holds the push-button knob in place is secured to the outside of the gate post by a pair of conventional wood screws (8). The Function of the rod is to push open the latch once the knob (1) is pressed and then securely close the latch once the knob (1) is released. This rod works directly with the push button knob (1), the Spring (11) and the E-clip (10). The Spring (11) is mounted on the end of the aluminum rod (6) closest to the gate latch and in front of the E-clip (10). Its function is that once the knob (1) is pushed from the outside of the gate post, the spring (11) along with the e-clip (10) extends the rod outward, which in turn opens up the gate latch. An E Clip (10) is mounted on the center rod (item #9) and on the end of the spring (11) farthest away from the gate latch, and is stationary. Its function is to push the center rod (9) and the spring at the same time toward a forward motion when the gate knob is pushed in order to open the gate latch. All of the mechanical components compromising of parts 3, 6-11 come pre-assembled for easier installation.

What is claimed is:

1. In combination with a gate latch both mounted on the same side of a hinged gate and a stationary gate post, a latch bar mounted on the said movable gate, and a latch bracket secured on the said stationary gate (wood post) and said post disposed for receiving the latch bar when the gate is in a closed position, a latch lever pivotally mounted to the latch bracket and including a recess dimensioned for partially surrounding the latch bar in a latched position.

2. A push-button knob assembly mounted on the stationary gate post via a cover plate.

3. The system of claim 2, wherein said push-button knob assembly opens the gate latch when pushed in.

4. The system of claim 2, wherein said button knob assembly screws on to a center rod which extends from the knob to the gate latch on the other side of the gate post.

5. The system of claim 4, wherein the center rod is attached to the gate latch on the other end via a Latch pin.

6. The system of claim 4, wherein the center rod resides inside two tubes which help keep it in place.

7. The system of claim 4, wherein an E-clip and a spring reside on the center rod.

8. The system of claim 7, wherein the E-Clip is mounted on the center rod and on the end of the spring farthest away from the gate latch, and is stationary.

9. The system of claim 8, where in the function of the E-clip is to push the center rod and the spring at the same time toward a forward motion when the gate knob is pushed in order to open the gate latch.

10. The system of claim 7, wherein a spring is mounted on the center rod, at the end of the aluminum rod closest to the gate latch and in front of the E-clip.

11. The system of claim 10, wherein the function of the spring is that once the knob is pushed from the outside of the gate post, the spring along with the e-clip extends the rod outward, which in turn opens up the gate latch releasing the center bar.

12. The system of claim 10. Wherein the function of the spring is that once the knob is released from the outside of the gate post, the spring along with the e-clip contract the rod back to its original position, which in turn closes the gate latch over the center bar, securing it in place.

13. The system of claim 4, wherein the length of the said center rod may be adjustable to fit various sized gate posts.

14. The system of claim 4, wherein the center rod sits in the middle of two other rods which keep it in place.

15. The system of claim 4, wherein the center rod is connected to the gate latch assembly via a pin.

16. The system of claims 11 and 12, wherein the rods, the gate latch assembly, the E-clip, the spring and the pin come pre-assembled for easier functionality.

17. The latch system of claim 1, wherein said latch assembly and said button knob assembly are adapted for mounting on said gate.
